(19) United States
(12) Patent Application Publication
(10) Pub. No.: US 2016/0005362 A1
(43) Pub. Date: Jan. 7, 2016

(54) Determination Of Optical Condition And Adjustment Of Display

(71) Applicant: MediaTek Inc., Hsinchu (TW)

(72) Inventors: Cheng-Che Chen, New Taipei City (TW); Yi-Ruei Wu, Tainan City (TW)

(21) Appl. No.: 14/847,730

(22) Filed: Sep. 8, 2015

(51) Int. Cl. G09G 3/34

(52) U.S. Cl. CPC G09G 3/3406; G09G 2320/0626; G09G 2360/144; G09G 2320/066

(57) ABSTRACT

Techniques and implementations related to determination of an optical condition surrounding a portable electronic apparatus and adjustment of display thereby are described. A method may involve sensing a property of an ambient light in at least a first direction and a second direction different from the first direction with respect to the portable electronic apparatus. The method may also involve determining whether any of one or more optical conditions is met based on the sensing. The one or more optical conditions may correspond to one of one or more scenarios surrounding the portable electronic apparatus, respectively. The method may further involve adjusting one or more operational parameters related to the portable electronic apparatus responsive to the determining.

### TECHNICAL FIELD

The present disclosure is generally related to digital imaging and, more particularly, to determination of optical condition surrounding an imaging device and automatic adjustment of a display thereof.

### BACKGROUND

Unless otherwise indicated herein, approaches described in this section are not prior art to the claims listed below and are not admitted to be prior art by inclusion in this section.

In present day, more and more portable electronic apparatuses, such as smartphones and tablet computers, are equipped with one or more optical components including a front-facing camera (facing toward a user of the portable electronic apparatus) on the front side of the portable electronic apparatus, a front-facing ambient light sensor, and a rear-facing camera (facing away from the user) on the rear side of the portable electronic apparatus. Typically, the front-facing ambient light sensor can only detect an optical or lighting condition to the front of the portable electronic apparatus, and an automatic backlight adjustment feature of a portable electronic apparatus can only utilize a sensing result of the front-facing ambient light sensor to make adjustment. Moreover, the rear-facing camera is typically turned on or otherwise activated only when necessary, e.g., when used by the user of the portable electronic apparatus.

When in use, the portable electronic apparatus may be situated in an environment in which ambient lighting surrounding the portable electronic apparatus may be rather complicated. As an example, when used for automobile navigation (e.g., near or on the dashboard and/or windshield of the automobile), the rear side of the portable electronic apparatus may be relatively brighter while the front side of the portable electronic apparatus may be relatively darker. However, due to using only the front-facing ambient light sensor to control the brightness of a content displayed by a display unit of the portable electronic apparatus, the brightness may be insufficient to result in the display unit being too dark.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve sensing a property of an ambient light in at least a first direction and a second direction different from the first direction with respect to the portable electronic apparatus. The method may also involve determining whether any of one or more optical conditions is met based on the sensing. The one or more optical conditions may correspond to one of one or more scenarios surrounding the portable electronic apparatus, respectively. The method may further involve adjusting one or more operational parameters related to the portable electronic apparatus responsive to the determining.

In another example implementation, a method may involve sensing a property of an ambient light in a first direction by an ambient light sensor associated with one or more first imaging devices facing at least the first direction. The method may also involve sensing the property of the ambient light in a second direction different from the first direction based at least in part on one or more still images, one or more video images, or a combination thereof captured by one or more second imaging devices facing at least the second direction. The method may further involve determining an optical condition surrounding a portable electronic apparatus having the one or more first imaging devices and the one or more second imaging devices based at least in part on the property of the ambient light in a plurality of directions comprising the first and the second directions. The method may additionally involve adjusting one or more operational parameters related to the portable electronic apparatus responsive to the determining.

In yet another example implementation, an apparatus may include one or more first imaging devices, an ambient light sensor, and one or more second imaging devices. The one or more first imaging devices may be configured to capture images in at least a first direction. The ambient light sensor may be configured to sense a property of an ambient light in the first direction. The one or more second imaging devices may be configured to capture images, and may face at least a second direction different from the first direction. The apparatus may also include one or more processors coupled to receive outputs of the one or more first imaging devices, the ambient light sensor and the one or more second imaging devices. The one or more processors may be configured to perform a number of operations. For instance, the one or more processors may determine a property of the ambient light in at least the first direction and the second direction. The one or more processors may also determine whether any of one or more optical conditions is met based on a determination of the property of the ambient light, the one or more optical conditions corresponding to one of one or more scenarios surrounding the apparatus. The one or more processors may further adjust one or more operational parameters related to the apparatus based at least in part on whether any of the one or more optical conditions is met.

Accordingly, implementations in accordance with the present disclosure may utilize optical components on both the front side and the rear side of a portable electronic apparatus to determine an optical condition surrounding the portable electronic apparatus. The optical components may include one or more ambient light sensors and one or more imaging devices. Advantageously, the determined optical condition may be utilized to adjust the brightness and/or content of a display unit of the portable electronic apparatus. Specifically, the brightness of light emitted by the display unit may be adjusted according to the optical condition or lighting scenario in which the portable electronic apparatus is situated. Moreover, the content displayed by the display unit may be adjusted according to the optical condition or lighting scenario in which the portable electronic apparatus is situated.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example environment in which various implementations in accordance with the present disclosure may be implemented.

FIG. 2 is a block diagram of an example algorithm in accordance with an implementation of the present disclosure.

FIG. 3 is a block diagram of an example algorithm in accordance with another implementation of the present disclosure.

FIG. 4 is a block diagram of an example apparatus in accordance with an implementations of the present disclosure.

FIG. 5 is a flowchart of an example process in accordance with an implementation of the present disclosure.

FIG. 6 is a flowchart of an example process in accordance with another implementation of the present disclosure.

### DETAILED DESCRIPTION OF PREFERRED EMBODIMENTS

### Overview

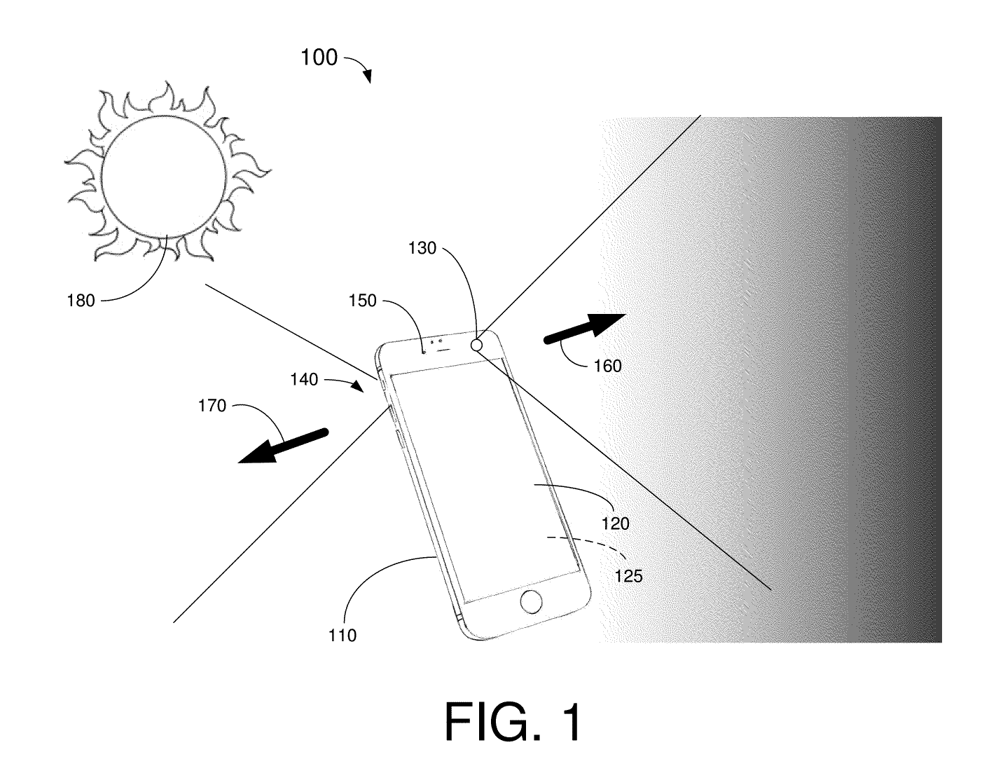

FIG. 1 illustrates an example environment 100 in which various implementations in accordance with the present disclosure may be implemented. Example environment 100 may include a portable electronic apparatus 110, e.g., a smartphone, a tablet computer or another type of apparatus suitable for implementation of techniques described herein. Portable electronic apparatus 110 may include a display unit 120 disposed on a front side of portable electronic apparatus 110 which would normally face a user of portable electronic apparatus 110 when in use by the user. That is, display unit 120 may be facing in a first direction 160, e.g., the front-facing direction with respect to portable electronic apparatus 110. Display unit 120 may include a backlight unit 125 configured to provide a backlight to illuminate display unit 120 from behind. Portable electronic apparatus 110 may also include one or more first imaging devices 130, e.g., a first camera, and an ambient light sensor 150 disposed on the front side thereof. That is, both first imaging device(s) 130 and ambient light sensor 150 may be facing in first direction 160, e.g., the front-facing direction in the example shown in FIG. 1. Portable electronic apparatus 110 may further include one or more second imaging devices 140, e.g., a second camera, disposed on a rear side thereof. That is, second imaging device(s) 140 may be facing in a second direction 170, e.g., the rear-facing direction in the example shown in FIG. 1, which is different from first direction 160. In some implementations, each of first direction 160 and second direction 170 may refer to a range of angles. For example, first direction 160 may cover a first range of angles on the front side of portable electronic apparatus 110, and second direction may cover a second range of angles on the rear side of portable electronic apparatus 110. The first range of angles and the second range of angles may be completely non-overlapped or partially overlapped with each other. In some implementations, first direction 160 and second direction 170 may differ by 180°. In some other implementations, first direction 160 and second direction 170 may differ by an angle other than 180°, e.g., greater than or less than 180°.

Portable electronic apparatus 110 may be in operation or otherwise in use by a user under a variety of lighting conditions or optical conditions. In the example shown in FIG. 1, portable electronic apparatus 110 is in operation with a light source 180, e.g., the sun, on the rear side of portable electronic apparatus 110. Moreover, portable electronic apparatus 110 may face or otherwise be situated in a dark environment. As a result, first imaging device(s) 130 and ambient light sensor 150 may be exposed to an optical condition very different than that to which second imaging device(s) 140 may be exposed. For instance, in the example shown in FIG. 1, if first imaging device(s) 130 and second imaging device(s) 140 were to take or otherwise capture still images and/or video images simultaneously or within a given time frame, the aperture N and/or exposure time t for first imaging device(s) 130 may need to be respectively greater than the aperture N and/or exposure time t for second imaging device(s) 140 since the ambient light in second direction 170 is relatively greater than the ambient light in first direction 160.

Some Implementations in accordance with the present disclosure may utilize optical components on both the front side and the rear side of portable electronic apparatus 110 to determine an optical condition surrounding portable electronic apparatus 110 and adjust a brightness and/or content associated with display unit 120 based on the determined optical condition. For instance, front-facing ambient light sensor 150 and rear-facing second imaging device(s) 140 of portable electronic apparatus 110 may be utilized to sense a property of the ambient light, e.g., brightness of ambient light, surrounding portable electronic apparatus 110. The rear-facing second imaging device(s) 140 may be continuously activated or periodically activated to sense the property of the ambient light on the rear side of portable electronic apparatus 110.

The sensing of a property, e.g., brightness, of ambient light may be achieved by one of a number of ways in accordance with the present disclosure. In some implementations, the brightness of ambient light may be sensed, measured, determined or otherwise obtained by using one or more still images, one or more video images, or a combination of one or more still images and one or more video images. For instance, when first imaging device(s) 130 or second imaging device(s) 140 is activated and is capturing still image(s) or video images, the brightness of ambient light at least one the respective side of portable electronic apparatus 110 may be determined using one or more still images, one or more video images, or a combination of one or more still images and one or more video images captured by first imaging device(s) 130 or second imaging device(s) 140. In some other implementations, the brightness of ambient light may be sensed, measured, determined or otherwise obtained by controlling one or more operational parameters related to the exposure of first imaging device(s) 130 or second imaging device(s) 140. For instance, when first imaging device(s) 130 or second imaging device(s) 140 is not in operation, first imaging device(s) 130 or second imaging device(s) 140 may be periodically activated to capture at least one image whenever it is activated so as to take or otherwise capture sample images which may be indicative of the brightness of ambient light at least on the respective side of portable electronic apparatus 110.

Under the same lighting condition (environmental brightness), the brightness of images captured by a camera or an imaging device, e.g., first imaging device(s) 130 and/or second imaging device(s) 140, is usually affected by three factors, namely: aperture N, exposure time t (or shutter speed), and ISO sensitivity. With respect to aperture, the greater the aperture N, the smaller the focal ratio or f-number. Generally, in mathematical terms, the amount of collected light associated with fn is twice the amount of collected light associated with f√2n. For example, the amount of collected light associated with f2.8 is twice of that associated with f4. With respect to exposure time t, a linear relationship exists between the amount of collected light and exposure time. With respect to ISO sensitivity, under a fixed amount of collected light, the greater the ISO sensitivity the brighter the resultant image will be. For example, the resultant brightness associated with ISO 200 is twice of that associated with ISO 100. Moreover, in photography, the exposure value (EV) denotes a number that represents a combination of a camera's shutter speed and f-number, such that all combinations that yield the same exposure have the same EV value (for any fixed scene luminance). In mathematical terms, exposure value may be expressed as EV=log 2(N²/t). The smaller the EV value, the greater the amount of collected light will be. For example, the amount of collected light associated with k−1 EV is twice of that associated k EV.

For purpose of explanation in the present disclosure, the brightness of ambient light sensed on the front side of portable electronic apparatus 110 (e.g., sensed by the front-facing ambient light sensor 150 and/or front-facing first imaging device(s) 130) may be denoted as L_{f}, and the brightness of ambient light sensed on the rear side of portable electronic apparatus 110 (e.g., sensed by the rear-facing second imaging device(s) 140) may be denoted as Lᵣ. As such the result of the sensing, (L_{f}, Lᵣ), may be utilized for one or more adjustments of display unit 120.

With L_{f} (e.g., sensed by the front-facing ambient light sensor 150 and/or front-facing first imaging device(s) 130) and Lᵣ (e.g., sensed by the rear-facing second imaging device(s) 140) determined, the scenario in which portable electronic apparatus 110 is situated may be estimated or otherwise determined using L_{f} and Lᵣ.

In some implementations, to determine the scenario, different lighting values may be calculated to represent a lighting distribution surrounding portable electronic apparatus 110. For example, a total amount of lighting and/or a lighting difference in different directions can be obtained according to lighting in the first direction (L_{f}) and lighting in the second direction (Lᵣ). Specifically, either or both of a weighted difference in lighting in the first direction (L_{f}) and lighting in the second direction (Lᵣ) and a weighted sum in lighting in the first direction (L_{f}) and lighting in the second direction (Lᵣ) may be determined and compared to one or more thresholds associated with the one or more scenarios.

In one implementation, the scenario in which portable electronic apparatus 110 is situated may be determined mathematically in accordance with equations (1) and (2) as follows:

Sₐ=W_{f}×L_{f}+Wᵣ×Lᵣ (1)

S_{d}=W_{f}×L_{f}−Wᵣ×Lᵣ (2)

In equations (1) and (2), W_{f} denotes a weighted factor for L_{f}, Wᵣ denotes a weighted factor for Lᵣ, Sₐ denotes a weighted sum in lighting in the first direction and the second direction, and S_{d} denotes a weighted difference in lighting between the first direction and the second direction. The weighted factors W_{f} and Wᵣ may be preconfigured as well as definable or otherwise configurable by the user.

In various implementations of the present disclosure, there may be a number of optical conditions corresponding to a number of scenarios in which portable electronic apparatus 110 may possibly be situated. With Sₐ and S_{d} calculated, computed or otherwise determined using equations (1) and (2), the optical condition and the corresponding scenario in which portable electronic apparatus 110 is situated may be determined in view of a number of thresholds associated with the number of scenarios. As an example for illustrative purpose and not limiting the scope of the present disclosure, the thresholds may include a first threshold Bₒᵤₜ, a second threshold B_{dim}, a third threshold B_{car}, and a fourth threshold S_{tb}. Accordingly, a number of example optical conditions and corresponding example scenarios in which portable electronic apparatus 110 may be situated are shown in Table 1 below.

TABLE 1
Optical Conditions and Corresponding Scenarios

| | Optical Condition | Scenario | Example Adjustment |
|---|---|---|---|
| 1 | Sₐ > Bₒᵤₜ | Outdoors | Increase backlight and |
| | | | contrast for display |
| 2 | Sₐ < B_{dim} | Extremely dark | Enter into low-light |
| | | | illumination mode |
| 3 | S_{d} < B_{car}, B_{car} < 0 | High-difference with | Increase backlight and |
| | | rear side brighter than | contrast for display |
| | | front side, perhaps in | and/or enter into |
| | | car | navigation mode |
| 4 | S_{d} > B_{tb}, B_{tb} > 0 | Dark on the rear side, | Enter into low-power |
| | | perhaps placed on | mode |
| | | tabletop | |

Referring to Table 1, a first optical condition (Sₐ>Bₒᵤₜ) may correspond to a first scenario in which portable electronic apparatus 110 may be situated in a front-bright-rear-bright (outdoors) scenario, e.g., portable electronic apparatus 110 may be outdoors. Referring to Table 1, a second optical condition (Sₐ<B_{dim}) may correspond to a second scenario in which portable electronic apparatus 110 may be situated in an extremely dark (extremely-dark) scenario, e.g., portable electronic apparatus 110 may be indoors. Referring to Table 1, a third optical condition (S_{d}<B_{car}, B_{car}<0) may correspond to a third scenario in which portable electronic apparatus 110 may be situated in a rear side-front side high-difference (high-difference) scenario where the brightness of ambient light on the rear side of portable electronic apparatus 110 is greater than the brightness of ambient light on the front side thereof, e.g., portable electronic apparatus 110 may be on or near the dashboard of a car and used for its navigation function. Referring to Table 1, a fourth optical condition (S_{d}>B_{tb}, B_{tb}>0) may correspond to a fourth scenario in which portable electronic apparatus 110 may be situated in an extremely-dark-on-rear-side (dark-back) scenario where the ambient light on the rear side of portable electronic apparatus 110 may be extremely dark, e.g., portable electronic apparatus 110 may be placed on a surface such as tabletop with the side having display unit 120 facing up. It is noted that although four optical conditions and corresponding scenarios are shown in Table 1, not all of them are required to be implemented in portable electronic apparatus 110. Moreover, various other scenarios judged by corresponding optical conditions by considering lightings along different directions can be alternatively or additively implemented in portable electronic apparatus 110.

In various implementations of the present disclosure, one or more adjustments may be made to one or more components of portable electronic apparatus 110 corresponding to the optical condition and scenario in which portable electronic apparatus 110 is situated. For instance, in an event that it is determined that portable electronic apparatus 110 is under the third optical condition S_{d}<B_{car}, B_{car}<0) and in the high-difference scenario, portable electronic apparatus 110 may make one or more of the following adjustments: increasing a brightness of backlight unit 125, increasing a contrast in a content of display unit 120, and activating a navigation display mode thereof. Similarly, in an event that it is determined that portable electronic apparatus 110 is under the fourth optical condition (S_{d}>B_{tb}, B_{tb}>0) and in the dark-back scenario, portable electronic apparatus 110 may make an adjustment by entering into a low-power mode. Likewise, in an event that it is determined that portable electronic apparatus 110 is under the first optical condition (Sₐ>Bₒᵤₜ) and in the outdoors scenario, portable electronic apparatus 110 may make one or more of the following adjustments: increasing the brightness of backlight unit 124 and increasing the contrast in the content of display unit 120. Moreover, in an event that it is determined that portable electronic apparatus 110 is under the second optical condition (Sₐ<B_{dim}) and in the extremely-dark scenario, portable electronic apparatus 110 may make an adjustment by entering into a low-light illumination mode. In addition, portable electronic apparatus 110 may respectively adjust the contrast, a color, or a sharpness of the content displayed by display unit 120 when portable electronic apparatus 110 is under each of the optical conditions in a corresponding scenario.

In general, in view of the above, when portable electronic apparatus 10 is equipped with more than one optical components L₁, L₂, . . . , Lₙ each of which positioned or otherwise oriented to sense or detect a property of ambient light in a respective direction or region, a function of scenario S may be expressed as S(L₁, L₂, . . . , Lₙ). Accordingly, adjustment may be made to each of a number of operational parameters related to portable electronic apparatus 110 based on S(L₁, L₂, . . . , Lₙ) and a content I as originally displayed by display unit 120. As an example, the operational parameter of display brightness of display unit 120, which may be expressed as B(S(L₁, L₂, . . . , Lₙ), I), may be adjusted, e.g., by controlling the amount of backlight emitted by backlight unit 125 and/or by controlling a gain of the content I. As another example, the operational parameter of display content of display unit 120, which may be expressed as P(S(L₁, L₂, . . . , Lₙ), I), may be adjusted, e.g., by modifying image processing of the content to control the contrast, color and/or sharpness of the content. As a further example, the operational parameter of display mode of display unit 120 may be adjusted, e.g., by switching to a daylight mode, a nighttime mode, a navigation mode or another special mode.

In some implementations in which the brightness of ambient light is sensed, measured, determined or otherwise obtained by using one or more still images, one or more video images, or a combination of one or more still images and one or more video images, there can be an assumption that the pixels of first imaging device(s) 130 and second imaging device(s) 140 have received lens and sensor calibration such that energy of light collected by the pixels is distributed among the pixels in a linear fashion. Using the rear-facing second imaging device(s) 140 as an example, the brightness of ambient light sensed by second imaging device(s) 140, Lᵣ, may be expressed mathematically as equation (3) below:

Lᵣ=c×2^{EV}×(100/ISO)×1/n×Σ(pixels in Y) (3)

In equation (3), n denotes the number of pixels (e.g., 640×480), Y denotes the brightness of each individual pixel (e.g., may be RGB value thereof) and ISO denotes the ISO setting of second imaging device(s) 140 (e.g., 100, 200, 400 or the like). The value of c may be obtained during sensor calibration, after which the value of c may be inserted in equation (3) to obtain the value of Lᵣ.

In some implementations in which the brightness of ambient light is sensed, measured, determined or otherwise obtained by controlling one or more operational parameters related to the exposure of an imaging device, the EV value and/or ISO setting of first imaging device(s) 130 and/or second imaging device(s) 140 may be continuously (or according to a desired timing) adjusted to identify the EV value and/or ISO setting most suitable for sensing the ambient light.

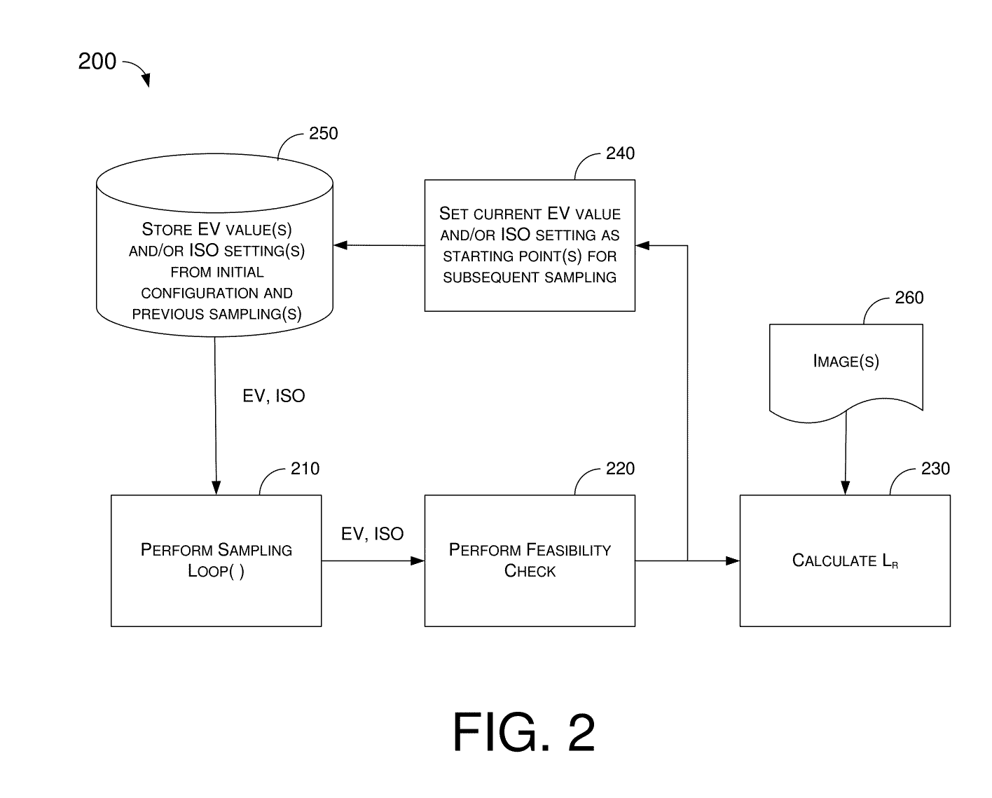

FIG. 2 illustrates an example algorithm 200 pertaining to identifying the EV value and/or ISO setting most suitable for sensing the ambient light. Example algorithm 200 may involve one or more operations, actions, or functions as represented by one or more of blocks 210, 220, 230, 240 and 250. Although illustrated as discrete blocks, various blocks of example algorithm 200 may be divided into additional blocks, combined into fewer blocks, or eliminated, depending on the desired implementation. Example algorithm 200 may be implemented by portable electronic apparatus 110 in example environment 100. For illustrative purposes, example algorithm 200 is described below in the context of being implemented by portable electronic apparatus 110 in example environment 100.

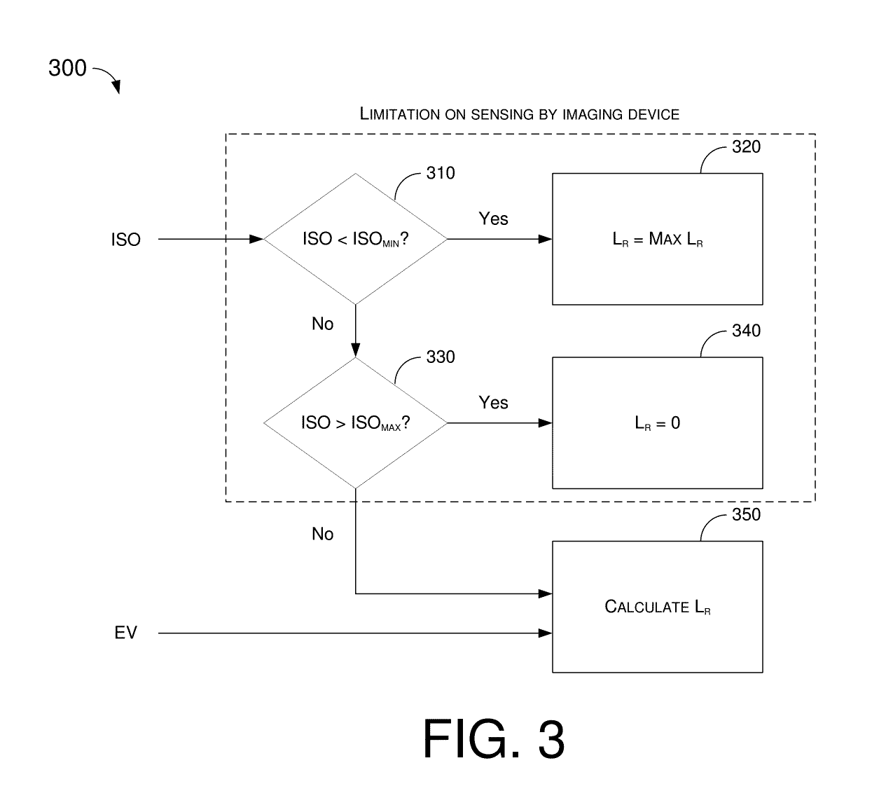

In example algorithm 200, the initial EV value and the initial ISO setting, for the sensing or detection for the first time, may be preconfigured and stored in portable electronic apparatus 110. For instance, the initial ISO setting may preconfigured to be the ISO setting with the highest signal-to-noise ratio (SNR) among multiple ISO settings of first imaging device(s) 130 and/or second imaging device(s) 140. Referring to FIG. 2, example algorithm 200 may begin at 210. At 210, example algorithm 200 may perform a sampling loop. Operation 210 may be performed to enable the setting of first imaging device(s) 130 or second imaging device(s) 140 to be in an appropriate exposure range. After performing the sampling loop, example algorithm 200 may proceed from 210 to 220. At 220, example algorithm 200 may perform feasibility check, an illustrative example of which is described below with reference to FIG. 3. After feasibility check, example algorithm 200 may proceed from 220 to 230. At 230, example algorithm 200 may calculate Lᵣ, the brightness of ambient light sensed on the rear side of portable electronic apparatus 110, sensed by second imaging device(s) 140 using one or more images 260 taken or otherwise captured by second imaging device(s) 140. In the calculation, equation (3) or any suitable equations may be employed. Example algorithm 200 may also proceed from 220 to 240. At 240, example algorithm 200 may set the current EV value and/or ISO setting as starting point(s) for the subsequent sampling. Example algorithm 200 may proceed from 240 to 250. At 250, example algorithm 200 may store the EV value(s) and/or ISO setting(s) from the initial configuration as well as from one or more previous samplings. The above operations may be repeated and in which case example algorithm 200 may proceed from 250 to 210.

For illustrative purpose and not limiting the scope of the present disclosure, an example sampling loop for use in 210 is provided below.

Loop {

Take picture by (EV, ISO) to obtain U and L
if |U| > T_{U} and |L| > T_{L}:

break loop

else if |U| > T_{U}

EV = min(EV + 1, EVₘₐₓ)

else if |L| > T_{L}

EV = max(EV − 1, EVₘᵢₙ)

else

break loop

if EV == EVₘₐₓ

ISO = ISO / 2

else if EV == EVₘᵢₙ

ISO = ISO * 2

if ISO < ISOₘᵢₙ or ISOₘₐₓ < ISO

break loop

}

In the example sampling loop above, U denotes a set or amount of pixels with overexposure, L denotes a set or amount of pixels with underexposure, EVₘₐₓ denotes the maximum EV value of an imaging device, EVₘᵢₙ denotes the minimum EV value of the imaging device, ISOₘₐₓ denotes the maximum ISO setting of a sensor, and ISOₘᵢₙ denotes the minimum ISO setting of the sensor. Additionally, T_{U} denotes the threshold of overexposure and T_{L} denotes the threshold of underexposure. Both T_{U} and T_{L} may be preconfigured as well as definable or otherwise configurable by the user. Moreover, in the example sampling loop above, the value of EV may be set to the value of the previous feasible EV, and the value of ISO may be set to the value of the previous feasible ISO.

During the performance of the sampling loop, either or both of first imaging device(s) 130 and second imaging device(s) 140 may be activated to take or otherwise capture images, and portable electronic apparatus 110 may compute, calculate or otherwise determine U (amount of pixels with overexposure) and L (amount of pixels with underexposure).

If both the amount of pixels with overexposure and the amount of pixels with underexposure exceed a respective threshold, T_{U} and T_{L}, then example algorithm 200 may stop the sampling. If the amount of pixels with overexposure exceeds T_{U}, then example algorithm 200 may increase the EV value of first imaging device(s) 130 or second imaging device(s) 140 to decrease the amount of collected light. If the amount of pixels with underexposure exceeds T_{L}, then example algorithm 200 may decrease the EV value of first imaging device(s) 130 or second imaging device(s) 140 to increase the amount of collected light. Otherwise, example algorithm 200 may deem that the setting of first imaging device(s) 130 or second imaging device(s) 140 is in an appropriate exposure range and, thus, stop the sampling.

Moreover, if the EV value has reached the maximum EV value for first imaging device(s) 130 or second imaging device(s) 140 while there is still overexposure, then example algorithm 200 may decrease the ISO value to lower the brightness of display unit 120, e.g., by dividing the ISO value by 2 or another number. On the contrary, if the EV value has reached the minimum EV value for first imaging device(s) 130 or second imaging device(s) 140 while there is still underexposure, then example algorithm 200 may increase the ISO value to enhance the brightness of display unit 120, e.g., by multiplying the ISO value by 2 or another number. Furthermore, if the ISO value is less than ISOₘᵢₙ or greater than ISOₘₐₓ, then example algorithm 200 may stop the sampling.

FIG. 3 illustrates an example algorithm 300 pertaining to performing a feasibility check in the context of example algorithm 200. Example algorithm 300 may involve one or more operations, actions, or functions as represented by one or more of blocks 310, 320, 330, 340 and 350. Although illustrated as discrete blocks, various blocks of example algorithm 300 may be divided into additional blocks, combined into fewer blocks, or eliminated, depending on the desired implementation. Example algorithm 300 may be implemented by portable electronic apparatus 110 in example environment 100. For illustrative purposes, example algorithm 300 is described below in the context of being implemented by portable electronic apparatus 110 in example environment 100.

Referring to FIG. 3, example algorithm 300 may begin at 310. At 310, example algorithm 300 may determine whether a current value of ISO is less than ISOₘᵢₙ. If it is determined that the current value of ISO is less than ISOₘᵢₙ, then example algorithm 300 may proceed from 310 to 320. At 320, example algorithm 300 may set the value of Lᵣ to the maximum value configurable for Lᵣ. If it is determined that the current value of ISO is not less than ISOₘᵢₙ, then example algorithm 300 may proceed from 310 to 330. At 330, example algorithm 300 may determine whether the current value of ISO is greater than ISOₘₐₓ. If it is determined that the current value of ISO is greater than ISOₘₐₓ, then example algorithm 300 may proceed from 330 to 340. At 340, example algorithm 300 may set the value of Lᵣ to zero. If it is determined that the current value of ISO is not greater than ISOₘₐₓ, then example algorithm 300 may proceed from 330 to 350. At 350, example algorithm 300 may calculate the value of Lᵣ with a current value of EV as an input. Operation 350 of example algorithm 300 may coincide with operation 230 of example algorithm 200. The operations at 310, 320, 330 and 340 may represent the limitation on sensing by second imaging device(s) 140. That is, if the current value of ISO exceeds either the maximum or minimum configurable value for ISO setting for second imaging device(s) 140, then the determined value of Lᵣ, representative of the brightness of ambient light sensed on the rear side of portable electronic apparatus 110, is set to the maximum allowable value for Lᵣ or zero, respectively. In view of the above, the value of Lᵣ may be determined according to example algorithm 200 and example algorithm 300.

### Example Implementations

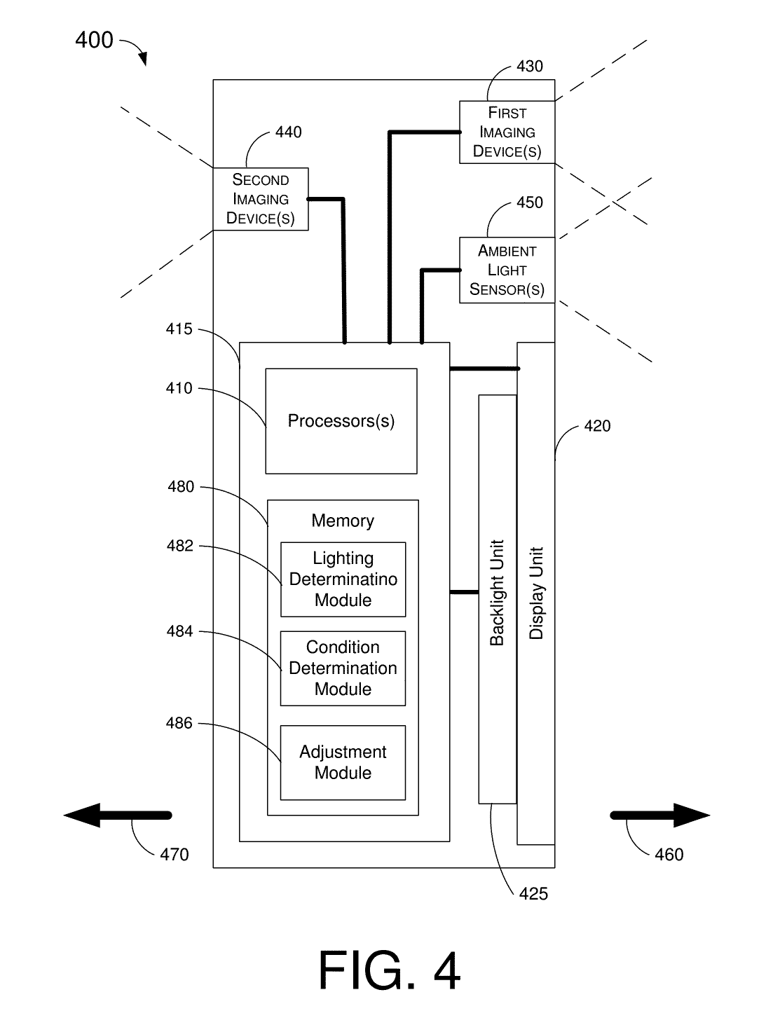

FIG. 4 illustrates an example apparatus 400 in accordance with an implementations of the present disclosure. Example apparatus 400 may perform various functions related to techniques, methods and systems described herein, including example algorithms 200 and 300 described above as well as example processes 500 and 600 described below. In some implementations, example apparatus 400 may be a portable electronic apparatus such as, for example, a smartphone, a computing device such as a tablet computer, a laptop computer, a notebook computer, or a wearable device, which is equipped with an imaging device, e.g., camera, capable of capturing still images and/or video images. Example apparatus 400 may be an implementation of portable electronic apparatus 110 in example environment 100.

Example apparatus 400 may include at least those components shown in FIG. 4, such as one or processors 410 and a memory device 480. In some implementations, the one or processors 410 and memory device 480 may be integral parts of a single integrated circuit (IC) chip 415 or a chipset, as shown in FIG. 4. Thus, in some implementations, example apparatus 400 may include IC chip 415 which includes one or more processors 410 and memory device 480. Alternatively, the one or processors 410 and memory device 480 may be discrete components separate from each other, e.g., each packaged in an individual chip.

In some implementations, as shown in FIG. 4, example apparatus 400 may additionally include one or more first imaging devices 430 (e.g., a first camera capable of capturing still images and/or video images), one or more second imaging devices 440 (e.g., a second camera capable of capturing still images and/or video images), and one or more ambient light sensors 450. In some implementations, as shown in FIG. 4, example apparatus 400 may further include a display unit 420 and a backlight unit 425. Display unit 420 may be, for example, a display panel or screen or a touch-sensing panel, which may be configured to display a content including still and/or video imagery. Backlight unit 425 may be configured to emit a backlight to illuminate the content of display unit 420.

Display unit 420 may be facing in a first direction 460, e.g., the front direction with respect to example apparatus 400. The one or more first imaging devices 430 and at least one of the one or more ambient light sensors 450 may be facing in at least first direction 460. The one or more second imaging devices 440 may be facing in at least a second direction 470, e.g., the rear-facing direction with respect to example apparatus 400, which is different from first direction 460. In some implementations, first direction 460 and second direction 470 may differ by 180°. In some other implementations, first direction 460 and second direction 470 may differ by an angle other than 180°, e.g., greater than or less than 180°.

Memory device 480 may be any type of random access memory (RAM), any type of read-only memory (ROM), or any suitable memory device configured to store data and one or more sets of instructions which may be in the form of software, middleware or firmware modules. Modules stored in memory device 480 may be executable by one or more processors 410 to perform a number of operations. In the example shown in FIG. 4, memory device 480 may store therein a lighting determination module 482, a condition determination module 484 and an adjustment module 486 each of which executable by one or more processors 410. Each of lighting determination module 482, condition determination module 484 and adjustment module 486 may be a software, middleware or firmware module executable by hardware circuits of one or more processors 410.

Upon execution, lighting determination module 482, condition determination module 484 and adjustment module 486 may cause one or more processors 410 to perform a number of operations. For instance, lighting determination module 482 may cause the one or more processors 410 to determine a property of ambient light in at least first direction 460 and second direction 470, e.g., using data outputted by the one or more first imaging devices 430, the one or more second imaging devices 440 and the one or more ambient light sensors 450. Condition determination module 484 may cause the one or more processors 410 to determine whether any of one or more optical conditions is met based on a determination of the property of the ambient light, the one or more optical conditions corresponding to one of one or more scenarios surrounding example apparatus 400. Adjustment module 486 may cause the one or more processors 410 to adjust one or more operational parameters related to example apparatus 400 based at least in part on whether any of the one or more optical conditions is met.

In some implementations, in determining whether any of the one or more optical conditions is met, the one or more processors 410 may perform a number of operations. For instance, the one or more processors 410 may determine either or both of a weighted difference in lighting between first direction 460 and second direction 470 and a weighted sum in lighting in first direction 460 and second direction 470. Moreover, the one or more processors 410 may compare the determined weighted difference in lighting between first direction 460 and second direction 470 to one or more thresholds associated with the one or more scenarios.

In some implementations, the one or more scenarios may include a high-difference scenario in which an amount of lighting in first direction 460 is less than an amount of lighting in second direction 470. In some implementations, an optical condition of the one or more optical conditions corresponding to the high-difference scenario may include a condition in which the weighted difference in lighting between first direction 460 and second direction 470 is less than a corresponding one of the one or more thresholds. Moreover, first direction 460 may correspond to a direction in which display unit 420 faces a user thereof, and second direction 470 may be opposite to first direction 460. In some implementations, when an optical condition of the one or more optical conditions corresponding to the high-difference scenario is determined to be met, in adjusting the one or more operational parameters related to example apparatus 400, the one or more processors 410 may perform one or more adjustments including, for example, increasing a brightness of backlight unit 425, increasing a contrast in a content of display unit 420, and activating a navigation display mode for example apparatus 400.

In some implementations, the one or more scenarios may include a dark-back scenario in which an amount of lighting in first direction 460 is greater than an amount of lighting in second direction 470. In some implementations, an optical condition of the one or more optical conditions corresponding to the dark-back scenario may include a condition in which the weighted difference in lighting between first direction 460 and second direction 470 is greater than a corresponding one of the one or more thresholds. Moreover, first direction 460 may correspond to a direction in which display unit 420 faces a user thereof, and second direction 470 may be opposite to first direction 460. In some implementations, when an optical condition of the one or more optical conditions corresponding to the dark-back scenario is determined to be met, in adjusting the one or more operational parameters related to example apparatus 400, the one or more processors 410 may enter into a low-power mode for example apparatus 400.

In some implementations, the one or more scenarios may include an outdoors scenario in which example apparatus 400 is outdoors. In some implementations, an optical condition of the one or more optical conditions corresponding to the outdoors scenario may include a condition in which the weighted sum in lighting in first direction 460 and second direction 470 is greater than a corresponding one of the one or more thresholds. In some implementations, when an optical condition of the one or more optical conditions corresponding to the outdoors scenario is determined to be met, in adjusting the one or more operational parameters related to example apparatus 400, the one or more processors 410 may perform one or more adjustments including, for example, increasing the brightness of backlight unit 425 and increasing the contrast in the content of display unit 420.

In some implementations, the one or more scenarios may include an extremely-dark scenario in which example apparatus 400 is in a dark environment. In some implementations, an optical condition of the one or more optical conditions corresponding to the extremely-dark scenario may include a condition in which the weighted sum in lighting in first direction 460 and second direction 470 is less than a corresponding one of the one or more thresholds. In some implementations, when an optical condition of the one or more optical conditions corresponding to the extremely-dark scenario is determined to be met, in adjusting the one or more operational parameters related to example apparatus 400, the one or more processors 410 may enter into a low-light illumination mode for example apparatus 400.

In some implementations, the one or more scenarios may include, for example, a first scenario in which example apparatus 400 is outdoors, a second scenario in which example apparatus 400 is in a dark environment, a third scenario in which an amount of lighting in first direction 460 is less than an amount of lighting in second direction 470, and a fourth scenario in which the amount of lighting in first direction 460 is greater than the amount of lighting in second direction 470. Additionally, first direction 460 may correspond to a direction in which display unit 420 faces a user thereof, and second direction 470 may be opposite to first direction 460. In some implementations, in adjusting the one or more operational parameters related to example apparatus 400, the one or more processors 410 may perform a number of operations. For instance, responsive to a determination that example apparatus 400 is in the first scenario, the one or more processors 410 may increase either or both of the brightness of backlight unit 425 and the contrast in the content of display unit 420. Responsive to a determination that example apparatus 400 is in the second scenario, the one or more processors 410 may enter into a low-light illumination mode for example apparatus 400. Responsive to a determination that example apparatus 400 is in the third scenario, the one or more processors 410 may perform one or more actions including, for example, increasing the brightness of backlight unit 425, increasing the contrast in the content of display unit 420, and activating a navigation display mode for example apparatus 400. Responsive to a determination that example apparatus 400 is in the fourth scenario, the one or more processors 410 may enter into a low-power mode for example apparatus 400.

In some implementations, in determining the property of the ambient light in at least first direction 460 and second direction 470, the one or more processors 410 may determine the property of the ambient light which is sensed simultaneously in at least first direction 460 and second direction 470.

In some implementations, in determining the property of the ambient light in at least first direction 460 and second direction 470, the one or more processors 410 may perform a number of operations. For instance, the one or more processors 410 may receive a first result of sensing of the property of the ambient light in first direction 460 by the ambient light sensor facing first direction 460. Additionally, the one or more processors 410 may receive a second result of sensing the property of the ambient light in second direction 470 based at least in part on one or more still images, one or more video images, or a combination thereof captured by the one or more second imaging devices 440 facing second direction 470. In some implementations, the one or more processors 410 may also periodically activate the one or more second imaging devices 440 to capture the one or more still images, the one or more video images, or the combination thereof. The one or more processors 410 may further determine the property of the ambient light in second direction 470 based at least in part on the captured one or more still images, the captured one or more video images, or the combination thereof.

In some implementations, in determining the property of the ambient light in second direction 470 based at least in part on the captured one or more still images, the captured one or more video images, or the combination thereof, the one or more processors 410 may determine the property of the ambient light in second direction 470 using exposure values and imaging device sensitivity values associated with either or both of still images and video images captured during a first time the one or more second imaging devices 440 was/were activated and during a second time the one or more second imaging devices 440 was/were activated after the first time. In some implementations, in determining the property of the ambient light in second direction 470 based at least in part on the captured one or more still images, the captured one or more video images, or the combination thereof, the one or more processors 410 may further perform a number of operations. For instance, the one or more processors 410 may determine a calibration factor of one or more second imaging devices 440 according to a calibration performed on the ambient light sensor. Additionally, the one or more processors 410 may calibrate, using the calibration factor, the property of the ambient light in second direction 470 obtained using the exposure values and the imaging device sensitivity values.

In some implementations, in adjusting the one or more operational parameters related to example apparatus 400, the one or more processors 410 may adjust either or both of the brightness of the content displayed by display unit 420 and the brightness of backlight unit 425.

In some implementations, in adjusting the one or more operational parameters related to example apparatus 400, the one or more processors 410 may adjust a contrast, a color, or a sharpness of a content displayed by display unit 420.

In some implementations, in adjusting the one or more operational parameters related to example apparatus 400, the one or more processors 410 may set an operational mode of example apparatus 400 to one of a plurality of operational modes in which example apparatus 400 operates, e.g., a daylight mode, a nighttime mode, a navigation mode, a low-power mode, a low-light illumination mode, or another special mode.

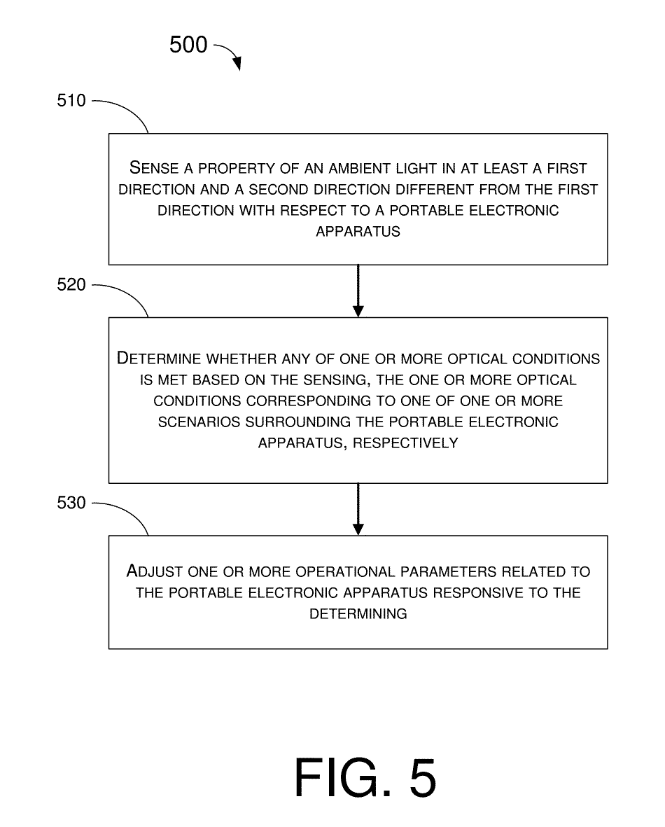

FIG. 5 illustrates an example process 500 in accordance with an implementation of the present disclosure. Example process 500 may include one or more operations, actions, or functions as represented by one or more of blocks 510, 520 and 530. Although illustrated as discrete blocks, various blocks of example process 500 may be divided into additional blocks, combined into fewer blocks, or eliminated, depending on the desired implementation. Example process 500 may be implemented by portable electronic apparatus 110 in example environment 100 and/or the one or more processors 410 of example apparatus 400. For illustrative purposes, operations of example process 500 are described below in the context of being performed by portable electronic apparatus 110 in example environment 100. Example process 500 may begin at 510.

At 510, example process 500 may involve portable electronic apparatus 110 sensing a property, e.g., brightness, of an ambient light in at least a first direction, e.g., first direction 160 by ambient light sensor 150, and a second direction different from the first direction, e.g., second direction 170 by second imaging device(s) 140, with respect to portable electronic apparatus 110. Example process 500 may proceed from 510 to 520.

At 520, example process 500 may involve portable electronic apparatus 110 determining whether any of one or more optical conditions is met based on a result of the sensing. The one or more optical conditions may correspond to one of one or more scenarios surrounding portable electronic apparatus 110, respectively. Example process 500 may proceed from 520 to 530.

At 530, example process 500 may involve portable electronic apparatus 110 adjusting one or more operational parameters related to the portable electronic apparatus responsive to the determining.

In some implementations, in determining whether any of the one or more optical conditions is met based on the sensing, example process 500 may involve portable electronic apparatus 110 performing a number of operations. For instance, example process 500 may involve portable electronic apparatus 110 determining either or both of a weighted difference in lighting between first direction 160 and second direction 170 and a weighted sum in lighting in first direction 160 and second direction 170. Additionally, example process 500 may involve portable electronic apparatus 110 comparing the determined weighted difference in lighting between first direction 160 and second direction 170 to one or more thresholds associated with the one or more scenarios.

In some implementations, the one or more scenarios may include a high-difference scenario in which an amount of lighting in first direction 160 is less than an amount of lighting in second direction 170. In some implementations, an optical condition of the one or more optical conditions corresponding to the high-difference scenario may include a condition in which the weighted difference in lighting between first direction 160 and second direction 170 is less than a corresponding one of the one or more thresholds. Moreover, first direction 160 may correspond to a direction in which display unit 120 faces a user thereof, and second direction 170 may be opposite to first direction 160, e.g., differing by approximately 180°. In some implementations, when an optical condition of the one or more optical conditions corresponding to the high-difference scenario is determined to be met, in adjusting the one or more operational parameters related to portable electronic apparatus 110 responsive to the determining, example process 500 may involve portable electronic apparatus 110 performing one or more adjustments. The one or more adjustments may include, for example and not limited to, one or more of the following: (1) increasing a brightness of backlight unit 125; (2) increasing a contrast in a content of display unit 120; and (3) activating a navigation display mode for portable electronic apparatus 110, e.g., invoking a navigation function such as Global Positioning System (GPS) of portable electronic apparatus 110.

In some implementations, the one or more scenarios may include a dark-back scenario in which an amount of lighting in first direction 160 is greater than an amount of lighting in second direction 170. In some implementations, an optical condition of the one or more optical conditions corresponding to the dark-back scenario may include a condition in which the weighted difference in lighting between first direction 160 and second direction 170 is greater than a corresponding one of the one or more thresholds. Moreover, first direction 160 may correspond to a direction in which display unit 120 faces a user thereof, and second direction 170 may be opposite to first direction 160, e.g., differing by approximately 180°. In some implementations, when an optical condition of the one or more optical conditions corresponding to the dark-back scenario is determined to be met, in adjusting the one or more operational parameters related to portable electronic apparatus 110 responsive to the determining, example process 500 may involve portable electronic apparatus 110 entering into a low-power mode.

In some implementations, the one or more scenarios may include an outdoors scenario in which portable electronic apparatus 110 is outdoors. In some implementations, an optical condition of the one or more optical conditions corresponding to the outdoors scenario may include a condition in which the weighted sum in lighting in first direction 160 and second direction 170 is greater than a corresponding one of the one or more thresholds. In some implementations, when an optical condition of the one or more optical conditions corresponding to the outdoors scenario is determined to be met, in adjusting the one or more operational parameters related to portable electronic apparatus 110 responsive to the determining, example process 500 may involve portable electronic apparatus 110 performing one or more adjustments. The one or more adjustments may include, for example and not limited to, one or more of the following: (1) increasing a brightness of backlight unit 125; and (2) increasing a contrast in a content of display unit 120.

In some implementations, the one or more scenarios may include an extremely-dark scenario in which portable electronic apparatus 110 is in a dark environment. In some implementations, an optical condition of the one or more optical conditions corresponding to the extremely-dark scenario may include a condition in which the weighted sum in lighting in first direction 160 and second direction 170 is less than a corresponding one of the one or more thresholds. In some implementations, when an optical condition of the one or more optical conditions corresponding to the extremely-dark scenario is determined to be met, in adjusting the one or more operational parameters related to portable electronic apparatus 110 responsive to the determining, example process 500 may involve portable electronic apparatus 110 entering into a low-light illumination mode.

In some implementations, the one or more scenarios may include one or more of the following: (1) a first scenario in which portable electronic apparatus 110 is outdoors; (2) a second scenario in which portable electronic apparatus 110 is in a dark environment; (3) a third scenario in which an amount of lighting in first direction 160 is less than an amount of lighting in second direction 170; and (4) a fourth scenario in which the amount of lighting in first direction 160 is greater than the amount of lighting in second direction 170. Moreover, first direction 160 may correspond to a direction in which display unit 120 faces a user thereof. Moreover, first direction 160 may correspond to a direction in which display unit 120 faces a user thereof. Furthermore, the first and second directions 160 and 170 may cover different ranges of angles which are completely not overlapped or partially overlapped. For example, second direction 170 may be opposite to first direction 160, e.g., differing by approximately 180°. In some implementations, in adjusting the one or more operational parameters related to portable electronic apparatus 110 responsive to the determining, example process 500 may involve portable electronic apparatus 110 performing one of the following: (1) increasing either or both of a brightness of backlight unit 125 and a contrast in a content of display unit 120 responsive to a determination that portable electronic apparatus 110 is in the first scenario; (2) entering into a low-light illumination mode for portable electronic apparatus 110 responsive to a determination that portable electronic apparatus 110 is in the second scenario; (3) performing one or more actions including (a) increasing the brightness of backlight unit 125, (b) increasing the contrast in the content of display unit 120, and (c) activating a navigation display mode for portable electronic apparatus 110 responsive to a determination that portable electronic apparatus 110 is in the third scenario; and (4) entering into a low-power mode for portable electronic apparatus 110 responsive to a determination that portable electronic apparatus 110 is in the fourth scenario.

In some implementations, in sensing the property of the ambient light in at least first direction 160 and second direction 170, example process 500 may involve portable electronic apparatus 110 simultaneously sensing the property of the ambient light in at least first direction 160 and second direction 170. For instance, example process 500 may involve portable electronic apparatus 110 sensing the property of the ambient light in first direction 160 by using ambient light sensor 150 which generally faces first direction 160. Additionally, example process 500 may involve portable electronic apparatus 110 sensing the property of the ambient light in second direction 170 based at least in part on one or more still images, one or more video images, or a combination thereof captured by second imaging device(s) 140 which generally faces second direction 170. In some implementations, in sensing the property of the ambient light in second direction 170 based at least in part on one or more still images, one or more video images, or a combination thereof captured by second imaging device(s) 140, example process 500 may involve portable electronic apparatus 110 periodically activating second imaging device(s) 140 to capture the one or more still images, the one or more video images, or a combination thereof each time second imaging device(s) 140 is activated. Furthermore, example process 500 may involve portable electronic apparatus 110 determining the property of the ambient light in second direction 170 based at least in part on the captured one or more still images, the captured one or more video images, or the combination thereof.

In some implementations, in determining the property of the ambient light in second direction 170 based at least in part on the captured one or more still images, the captured one or more video images, or the combination thereof, example process 500 may involve portable electronic apparatus 110 determining the property of the ambient light in second direction 170 using exposure values and imaging device sensitivity values associated with either or both of still images and video images captured during a first time second imaging device(s) 140 was activated and during a second time second imaging device(s) 140 was activated after the first time. In some further implementations, in determining of the property of the ambient light in second direction 170 based at least in part on the captured one or more still images, the captured one or more video images, or the combination thereof, example process 500 may further involve portable electronic apparatus 110 determining a calibration factor of second imaging device(s) 140 according to a calibration performed on the ambient light sensor. Example process 500 may additionally involve portable electronic apparatus 110 calibrating, using the calibration factor, the property of the ambient light in second direction 170 obtained using the exposure values and the imaging device sensitivity values.

In some implementations, in adjusting the one or more operational parameters related to portable electronic apparatus 110, example process 500 may involve portable electronic apparatus 110 adjusting either or both of a brightness of a content displayed by display unit 120 and a brightness of backlight unit 125. Alternatively or additionally, example process 500 may involve portable electronic apparatus 110 operating in different operating modes.

In some implementations, in adjusting the one or more operational parameters related to portable electronic apparatus 110, example process 500 may involve portable electronic apparatus 110 adjusting a contrast, a color, or a sharpness of a content displayed by display unit 120.

In some implementations, in adjusting the one or more operational parameters related to portable electronic apparatus 110, example process 500 may involve portable electronic apparatus 110 setting an operational mode thereof to one of a number of operational modes in which portable electronic apparatus 110 operates.

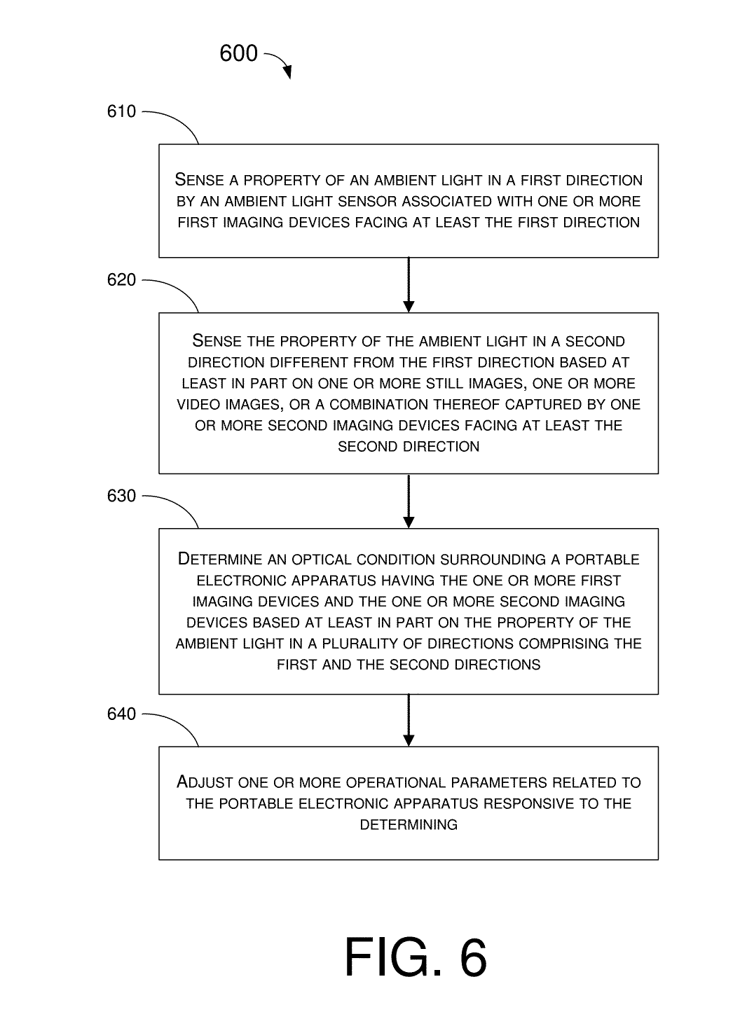

FIG. 6 illustrates an example process 600 in accordance with an implementation of the present disclosure. Example process 600 may include one or more operations, actions, or functions as represented by one or more of blocks 610, 620, 630 and 640. Although illustrated as discrete blocks, various blocks of example process 600 may be divided into additional blocks, combined into fewer blocks, or eliminated, depending on the desired implementation. Example process 600 may be implemented by portable electronic apparatus 110 in example environment 100 and/or the one or more processors 410 of example apparatus 400. For illustrative purposes, operations of example process 600 are described below in the context of being performed by the one or more processors 410 of example apparatus 400. Example process 600 may begin at 610.

At 610, example process 600 may involve the one or more processors 410 sensing a property of an ambient light in first direction 460 by the one or more ambient light sensors 450 facing first direction 460. Example process 600 may proceed from 610 to 620.

At 620, example process 600 may involve the one or more processors 410 sensing the property of the ambient light in second direction 470, which is different from first direction 460, based at least in part on one or more still images, one or more video images, or a combination thereof captured by one or more second imaging devices 440 facing second direction 470. Example process 600 may proceed from 620 to 630.

At 630, example process 600 may involve the one or more processors 410 determining an optical condition surrounding example apparatus 400 having one or more first imaging devices 430 and one or more second imaging devices 440 based at least in part on the property of the ambient light in a plurality of directions including first direction 460 and second direction 470. Example process 600 may proceed from 630 to 640.

At 640, example process 600 may involve the one or more processors 410 adjusting one or more operational parameters related to example apparatus 400 responsive to the determining.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
sensing a property of an ambient light in at least a first direction and a second direction different from the first direction with respect to a portable electronic apparatus;
determining whether any of one or more optical conditions is met based on the sensing, the one or more optical conditions corresponding to one of one or more scenarios surrounding the portable electronic apparatus, respectively; and
adjusting one or more operational parameters related to the portable electronic apparatus responsive to the determining.

2. The method of claim 1, wherein the determining of whether any of the one or more optical conditions is met based on the sensing comprises:
determining either or both of a weighted difference in lighting between the first direction and the second direction and a weighted sum in lighting in the first direction and the second direction; and
comparing the determined weighted difference in lighting between the first direction and the second direction to one or more thresholds associated with the one or more scenarios.

3. The method of claim 2, wherein the one or more scenarios comprise a high-difference scenario in which an amount of lighting in the first direction is less than an amount of lighting in the second direction.

4. The method of claim 3, wherein an optical condition of the one or more optical conditions corresponding to the high-difference scenario comprises a condition in which the weighted difference in lighting between the first direction and the second direction is less than a corresponding one of the one or more thresholds, wherein:
the first direction corresponds to a direction in which a display unit of the portable electronic apparatus faces a user thereof, and
the second direction is opposite to the first direction.

5. The method of claim 3, wherein, when an optical condition of the one or more optical conditions corresponding to the high-difference scenario is determined to be met, the adjusting of the one or more operational parameters related to the portable electronic apparatus responsive to the determining comprises performing one or more adjustments comprising:
increasing a brightness of a backlight unit of the portable electronic apparatus;
increasing a contrast in a content of a display unit of the portable electronic apparatus; and
activating a navigation display mode for the portable electronic apparatus.

6. The method of claim 2, wherein the one or more scenarios comprise a dark-back scenario in which an amount of lighting in the first direction is greater than an amount of lighting in the second direction.

7. The method of claim 6, wherein an optical condition of the one or more optical conditions corresponding to the dark-back scenario comprises a condition in which the weighted difference in lighting between the first direction and the second direction is greater than a corresponding one of the one or more thresholds, wherein:
the first direction corresponds to a direction in which a display unit of the portable electronic apparatus faces a user thereof, and
the second direction is opposite to the first direction.

8. The method of claim 6, wherein, when an optical condition of the one or more optical conditions corresponding to the dark-back scenario is determined to be met, the adjusting of the one or more operational parameters related to the portable electronic apparatus responsive to the determining comprises entering into a low-power mode for the portable electronic apparatus.

9. The method of claim 2, wherein the one or more scenarios comprise an outdoors scenario in which the portable electronic apparatus is outdoors.

10. The method of claim 9, wherein an optical condition of the one or more optical conditions corresponding to the outdoors scenario comprises a condition in which the weighted sum in lighting in the first direction and the second direction is greater than a corresponding one of the one or more thresholds.

11. The method of claim 9, wherein, when an optical condition of the one or more optical conditions corresponding to the outdoors scenario is determined to be met, the adjusting of the one or more operational parameters related to the portable electronic apparatus responsive to the determining comprises performing one or more adjustments comprising:
increasing a brightness of a backlight unit of the portable electronic apparatus; and
increasing a contrast in a content of a display unit of the portable electronic apparatus.

12. The method of claim 2, wherein the one or more scenarios comprise an extremely-dark scenario in which the portable electronic apparatus is in a dark environment.

13. The method of claim 12, wherein an optical condition of the one or more optical conditions corresponding to the extremely-dark scenario comprises a condition in which the weighted sum in lighting in the first direction and the second direction is less than a corresponding one of the one or more thresholds.

14. The method of claim 12, wherein, when an optical condition of the one or more optical conditions corresponding to the extremely-dark scenario is determined to be met, the adjusting of the one or more operational parameters related to the portable electronic apparatus responsive to the determining comprises entering into a low-light illumination mode for the portable electronic apparatus.

15. The method of claim 1, wherein the one or more scenarios comprise:
a first scenario in which the portable electronic apparatus is outdoors;
a second scenario in which the portable electronic apparatus is in a dark environment;
a third scenario in which an amount of lighting in the first direction is less than an amount of lighting in the second direction; and
a fourth scenario in which the amount of lighting in the first direction is greater than the amount of lighting in the second direction,
wherein:
the first direction corresponds to a direction in which a display unit of the portable electronic apparatus faces a user thereof, and
the second direction is opposite to the first direction.

16. The method of claim 15, wherein the adjusting of the one or more operational parameters related to the portable electronic apparatus responsive to the determining comprises:
increasing either or both of a brightness of a backlight unit of the portable electronic apparatus and a contrast in a content of a display unit of the portable electronic apparatus responsive to a determination that the portable electronic apparatus is in the first scenario;
entering into a low-light illumination mode for the portable electronic apparatus responsive to a determination that the portable electronic apparatus is in the second scenario;
performing one or more of increasing the brightness of the backlight unit, increasing the contrast in the content of the display unit of the portable electronic apparatus, and activating a navigation display mode for the portable electronic apparatus responsive to a determination that the portable electronic apparatus is in the third scenario; and
entering into a low-power mode for the portable electronic apparatus responsive to a determination that the portable electronic apparatus is in the fourth scenario.

17. The method of claim 1, wherein the sensing of the property of the ambient light in at least the first direction and the second direction comprises simultaneously sensing the property of the ambient light in at least the first direction and the second direction.

18. The method of claim 1, wherein the sensing of the property of the ambient light in at least the first direction and the second direction comprises:
sensing the property of the ambient light in the first direction by an ambient light sensor facing the first direction; and
sensing the property of the ambient light in the second direction based at least in part on one or more still images, one or more video images, or a combination thereof captured by an imaging device facing the second direction.

19. The method of claim 18, wherein the sensing of the property of the ambient light in the second direction based at least in part on one or more still images, one or more video images, or a combination thereof captured by a imaging device facing the second direction comprises:
periodically activating the imaging device facing the second direction to capture the one or more still images, the one or more video images, or a combination thereof each time the imaging device facing the second direction is activated; and
determining the property of the ambient light in the second direction based at least in part on the captured one or more still images, the captured one or more video images, or the combination thereof.

20. The method of claim 18, wherein the determining of the property of the ambient light in the second direction based at least in part on the captured one or more still images, the captured one or more video images, or the combination thereof comprises determining the property of the ambient light in the second direction using exposure values and imaging device sensitivity values associated with either or both of still images and video images captured during a first time the imaging device facing the second direction was activated and during a second time the imaging device facing the second direction was activated after the first time.

21. The method of claim 20, wherein the determining of the property of the ambient light in the second direction based at least in part on the captured one or more still images, the captured one or more video images, or the combination thereof further comprises:
determining a calibration factor of the imaging device facing the second direction according to a calibration performed on the ambient light sensor; and
calibrating, using the calibration factor, the property of the ambient light in the second direction obtained using the exposure values and the imaging device sensitivity values.

22. The method of claim 1, wherein the adjusting of the one or more operational parameters related to the portable electronic apparatus comprises adjusting either or both of a brightness of a content displayed by a display unit of the portable electronic apparatus and a brightness of a backlight unit of the portable electronic apparatus.

23. The method of claim 1, wherein the adjusting of the one or more operational parameters related to the portable electronic apparatus comprises adjusting a contrast, a color, or a sharpness of a content displayed by a display unit of the portable electronic apparatus.

24. The method of claim 1, wherein the adjusting of the one or more operational parameters related to the portable electronic apparatus comprises setting an operational mode of the portable electronic apparatus to one of a plurality of operational modes in which the portable electronic apparatus operates.

25. A method, comprising:
sensing a property of an ambient light in a first direction by an ambient light sensor associated with one or more first imaging devices facing at least the first direction;
sensing the property of the ambient light in a second direction different from the first direction based at least in part on one or more still images, one or more video images, or a combination thereof captured by one or more second imaging devices facing at least the second direction;
determining an optical condition surrounding a portable electronic apparatus having the one or more first imaging devices and the one or more second imaging devices based at least in part on the property of the ambient light in a plurality of directions comprising the first and the second directions; and
adjusting one or more operational parameters related to the portable electronic apparatus responsive to the determining.

26. An apparatus, comprising:
one or more first imaging devices configured to capture images in at least a first direction;
an ambient light sensor associated with the one or more first imaging devices, the ambient light sensor configured to sense a property of an ambient light in the first direction;
one or more second imaging devices configured to capture images, the one or more second imaging devices facing at least a second direction different from the first direction; and
one or more processors coupled to receive outputs of the one or more first imaging devices, the ambient light sensor and the one or more second imaging devices, the one or more processors configured to perform operations comprising:
determining a property of the ambient light in at least the first direction and the second direction;
determining whether any of one or more optical conditions is met based on a determination of the property of the ambient light, the one or more optical conditions corresponding to one of one or more scenarios surrounding the apparatus; and
adjusting one or more operational parameters related to the apparatus based at least in part on whether any of the one or more optical conditions is met.

27. The apparatus of claim 26, wherein, in determining whether any of the one or more optical conditions is met, the one or more processors are configured to perform operations comprises:
determining either or both of a weighted difference in lighting between the first direction and the second direction and a weighted sum in lighting in the first direction and the second direction; and
comparing the determined weighted difference in lighting between the first direction and the second direction to one or more thresholds associated with the one or more scenarios.

28. The apparatus of claim 27, wherein the one or more scenarios comprise a high-difference scenario in which an amount of lighting in the first direction is less than an amount of lighting in the second direction.

29. The apparatus of claim 28, further comprising a display unit, wherein an optical condition of the one or more optical conditions corresponding to the high-difference scenario comprises a condition in which the weighted difference in lighting between the first direction and the second direction is less than a corresponding one of the one or more thresholds, wherein:
the first direction corresponds to a direction in which the display unit faces a user thereof, and
the second direction is opposite to the first direction.

30. The apparatus of claim 28, further comprising a backlight unit and a display unit, wherein, when an optical condition of the one or more optical conditions corresponding to the high-difference scenario is determined to be met, in adjusting the one or more operational parameters related to the apparatus, the one or more processors are configured to perform one or more adjustments comprising:
increasing a brightness of the backlight unit;
increasing a contrast in a content of the display unit; and
activating a navigation display mode for the apparatus.

31. The apparatus of claim 27, wherein the one or more scenarios comprise a dark-back scenario in which an amount of lighting in the first direction is greater than an amount of lighting in the second direction.

32. The apparatus of claim 31, further comprising a display unit, wherein an optical condition of the one or more optical conditions corresponding to the dark-back scenario comprises a condition in which the weighted difference in lighting between the first direction and the second direction is greater than a corresponding one of the one or more thresholds, wherein:
the first direction corresponds to a direction in which the display unit faces a user thereof, and
the second direction is opposite to the first direction.

33. The apparatus of claim 31, wherein, when an optical condition of the one or more optical conditions corresponding to the dark-back scenario is determined to be met, in adjusting the one or more operational parameters related to the apparatus, the one or more processors are configured to enter into a low-power mode for the apparatus.

34. The apparatus of claim 27, wherein the one or more scenarios comprise an outdoors scenario in which the apparatus is outdoors.

35. The apparatus of claim 34, wherein an optical condition of the one or more optical conditions corresponding to the outdoors scenario comprises a condition in which the weighted sum in lighting in the first direction and the second direction is greater than a corresponding one of the one or more thresholds.

36. The apparatus of claim 34, further comprising a backlight unit and a display unit, wherein, when an optical condition of the one or more optical conditions corresponding to the outdoors scenario is determined to be met, in adjusting the one or more operational parameters related to the apparatus, the one or more processors are configured to perform one or more adjustments comprising:
increasing a brightness of the backlight unit; and
increasing a contrast in a content of the display unit.

37. The apparatus of claim 27, wherein the one or more scenarios comprise an extremely-dark scenario in which the apparatus is in a dark environment.

38. The apparatus of claim 37, wherein an optical condition of the one or more optical conditions corresponding to the extremely-dark scenario comprises a condition in which the weighted sum in lighting in the first direction and the second direction is less than a corresponding one of the one or more thresholds.

39. The apparatus of claim 37, wherein, when an optical condition of the one or more optical conditions corresponding to the extremely-dark scenario is determined to be met, in adjusting the one or more operational parameters related to the apparatus, the one or more processors are configured to enter into a low-light illumination mode for the apparatus.

40. The apparatus of claim 26, further comprising a display unit, wherein the one or more scenarios comprise:
a first scenario in which the apparatus is outdoors;
a second scenario in which the apparatus is in a dark environment;
a third scenario in which an amount of lighting in the first direction is less than an amount of lighting in the second direction; and
a fourth scenario in which the amount of lighting in the first direction is greater than the amount of lighting in the second direction,
wherein:
the first direction corresponds to a direction in which the display unit faces a user thereof, and
the second direction is opposite to the first direction.

41. The apparatus of claim 40, further comprising a backlight unit, wherein, in adjusting the one or more operational parameters related to the apparatus, the one or more processors are configured to perform operations comprising:
increasing either or both of a brightness of the backlight unit and a contrast in a content of the display unit responsive to a determination that the apparatus is in the first scenario;
entering into a low-light illumination mode for the apparatus responsive to a determination that the apparatus is in the second scenario;
performing one or more of increasing the brightness of the backlight unit, increasing the contrast in the content of the display unit, and activating a navigation display mode for the apparatus responsive to a determination that the apparatus is in the third scenario; and
entering into a low-power mode for the apparatus responsive to a determination that the apparatus is in the fourth scenario.

42. The apparatus of claim 26, wherein, in determining the property of the ambient light in at least the first direction and the second direction, the one or more processors are configured to determine the property of the ambient light which is sensed simultaneously in at least the first direction and the second direction.

43. The apparatus of claim 26, wherein, in determining the property of the ambient light in at least the first direction and the second direction, the one or more processors are configured to perform operations comprising:
receiving a first result of sensing of the property of the ambient light in the first direction by the ambient light sensor facing the first direction; and
receiving a second result of sensing the property of the ambient light in the second direction based at least in part on one or more still images, one or more video images, or a combination thereof captured by the one or more second imaging devices facing the second direction.

44. The apparatus of claim 43, wherein the one or more processors are further configured to perform operations comprising:
periodically activating the one or more second imaging devices to capture the one or more still images, the one or more video images, or the combination thereof; and
determining the property of the ambient light in the second direction based at least in part on the captured one or more still images, the captured one or more video images, or the combination thereof.

45. The apparatus of claim 44, wherein, in determining the property of the ambient light in the second direction based at least in part on the captured one or more still images, the captured one or more video images, or the combination thereof, the one or more processors are configured to determine the property of the ambient light in the second direction using exposure values and imaging device sensitivity values associated with either or both of still images and video images captured during a first time the one or more second imaging devices were activated and during a second time the one or more second imaging devices were activated after the first time.

46. The apparatus of claim 45, wherein, in determining the property of the ambient light in the second direction based at least in part on the captured one or more still images, the captured one or more video images, or the combination thereof, the one or more processors are further configured to perform operations comprising:
determining a calibration factor of the one or more second imaging devices according to a calibration performed on the ambient light sensor; and
calibrating, using the calibration factor, the property of the ambient light in the second direction obtained using the exposure values and the imaging device sensitivity values.

47. The apparatus of claim 26, further comprising a display unit and a backlight unit, wherein, in adjusting the one or more operational parameters related to the apparatus, the one or more processors are configured to adjust either or both of a brightness of a content displayed by the display unit and a brightness of the backlight unit.

48. The apparatus of claim 26, further comprising a display unit, wherein, in adjusting the one or more operational parameters related to the apparatus, the one or more processors are configured to adjust a contrast, a color, or a sharpness of a content displayed by the display unit.

49. The apparatus of claim 26, wherein, in adjusting the one or more operational parameters related to the apparatus, the one or more processors are configured to set an operational mode of the apparatus to one of a plurality of operational modes in which the apparatus operates.
